(19) United States
(12) Patent Application Publication
(10) Pub. No.: US 2018/0365258 A1
(43) Pub. Date: Dec. 20, 2018

(54) ARTIFICIAL INTELLIGENCE-BASED SEARCHING METHOD AND APPARATUS, DEVICE AND COMPUTER-READABLE STORAGE MEDIUM

(71) Applicant: BEIJING BAIDU NETCOM SCIENCE AND TECHNOLOGY CO., LTD., Haidian District Beijing (CN)

(72) Inventors: Yongxiang HUANG, Haidian District (CN); Chao ZHOU, Haidian District (CN); Yin ZHANG, Haidian District (CN); Wei XU, Haidian District (CN)

(73) Assignee: BEIJING BAIDU NETCOM SCIENCE AND TECHNOLOGY CO., L TD., Haidian District Beijing (CN)

(21) Appl. No.: 16/008,603

(22) Filed: Jun. 14, 2018

(30) Foreign Application Priority Data
Jun. 15, 2017 (CN) 2017104520507

(51) Int. Cl. G06F 17/30; G06N 5/02

(52) U.S. Cl. CPC G06F 17/3097; G06N 5/022; G06F 17/30979

(57) ABSTRACT

The present disclosure provides an artificial intelligence-based searching method and apparatus, a device and a computer-readable storage medium. In embodiments of the present disclosure, the search demand type is obtained according to the search keyword provided by the user, then the demand keyword is obtained according to the search keyword and the search pattern of the search demand type so that the search result can be obtained according to the demand keyword, and be output. Since the search operation is performed not completely depending on the search keyword provided by the user, but performed in conjunction with the demand keyword obtained according to the search demand type to which the search keyword belongs, the search result substantially satisfies the user's real intention.

The present application claims the priority of Chinese Patent Application No. 2017104520507, filed on Jun. 15, 2017, with the title of “Artificial intelligence-based searching method and apparatus, device and computer-readable storage medium”. The disclosure of the above applications is incorporated herein by reference in its entirety.

### FIELD OF THE DISCLOSURE

The present disclosure relates to searching technologies, and particularly to an artificial intelligence-based searching method and apparatus, a device and a computer-readable storage medium.

### BACKGROUND OF THE DISCLOSURE

Artificial intelligence AI is a new technical science for researching and developing theories, methods, technologies and application systems for simulating, extending and expanding human intelligence. Artificial intelligence is a branch of computer sciences and attempts to learn about the essence of intelligence, and produces a type of new intelligent machines capable of responding in a manner similar to human intelligence. The studies in the field comprise robots, language recognition, image recognition, natural language processing, expert systems and the like.

A search engine searches for information from the Internet according to certain policies and by running a specific computer program, organizes and processes the information, then provides search service for the user, and displays information about user's search to the system of the user. According to reports of National Bureau of Statistics of the People's Republic of China, the number of China's Internet users already exceeds 0.4 billion. The number means that China already surpasses the United States and becomes the world's first largest Internet user country. Furthermore, the total number of China's websites already exceeds two million. Therefore, how to use the search service to meet user's demands to a maximum degree is always an important subject for Internet enterprises. The user may provide a search keyword to a relevant application, and the application sends the search keyword to the search engine. The search engine searches in a database according to the search keyword to obtain a search result matched with the search keyword, and returns the search result to the application for output.

However, since the search keyword provided by the user might not be very proper, for example, the search keyword is too colloquial, grammar is not strict and the keyword is incomplete, performing a search operation completely depending on the search keyword might cause the search result to fail to satisfy the user's real intention so that the user has to perform search again and again through the application. This increases data interaction between the application and the search engine, and thereby causes the increase of the processing burden of the search engine.

### SUMMARY OF THE DISCLOSURE

A plurality of aspects of the present disclosure provide an artificial intelligence-based searching method and apparatus, a device and a computer-readable storage medium, to reduce the processing burden of the search engine.

According to an aspect of the present disclosure, there is provided an artificial intelligence-based searching method, comprising:

obtaining a search demand type according to a search keyword provided by the user;

obtaining a demand keyword according to the search keyword and a search pattern of the search demand type;

obtaining a search result according to the demand keyword;

outputting the search result.

The above aspect and any possible implementation mode further provide an implementation mode: before obtaining a search demand type according to a search keyword provided by the user, the method further comprises:

obtaining commonly-used keywords in a designated field;

classifying the commonly-used keywords to obtain at least one search demand type in the designated field.

The above aspect and any possible implementation mode further provide an implementation mode: the designated field comprises the field of ancient poetry.

The above aspect and any possible implementation mode further provide an implementation mode: the search demand type comprises precise demand type, type demand type or generic demand type.

The above aspect and any possible implementation mode further provide an implementation mode: the outputting the search result comprises:

ranking the search results according to heat data of the search results and the user's user inclinations;

outputting the ranked search results.

According to another aspect of the present disclosure, there is provided an artificial intelligence-based searching apparatus, comprising:

a semantic parsing unit configured to obtain a search demand type according to a search keyword provided by the user;

a semantic matching unit configured to obtain a demand keyword according to the search keyword and a search pattern of the search demand type;

a result obtaining unit configured to obtain a search result according to the demand keyword;

a result outputting unit configured to output the search result.

The above aspect and any possible implementation mode further provide an implementation mode: the semantic parsing unit is further configured to

obtain commonly-used keywords in a designated field; and

classify the commonly-used keywords to obtain at least one search demand type in the designated field.

The above aspect and any possible implementation mode further provide an implementation mode: the designated field comprises the field of ancient poetry.

The above aspect and any possible implementation mode further provide an implementation mode: the search demand type comprises precise demand type, type demand type or generic demand type.

The above aspect and any possible implementation mode further provide an implementation mode: the outputting unit is specifically configured to

rank the search results according to heat data of the search results and the user's user inclinations; and

output the ranked search results.

According to a further aspect of the present disclosure, there is provided a device, wherein the device comprises:

one or more processors;

a memory for storing one or more programs,

the one or more programs, when executed by said one or more processors, enabling said one or more processors to implement the artificial intelligence-based searching method according to one of the above aspects.

According to another aspect of the present disclosure, there is provided a computer readable medium on which a computer program is stored, wherein the program, when executed by a processor, implements the artificial intelligence-based searching method according to one of the above aspects.

As known from the above technical solutions, in embodiments of the present disclosure, the search demand type is obtained according to the search keyword provided by the user, then the demand keyword is obtained according to the search keyword and the search pattern of the search demand type so that the search result can be obtained according to the demand keyword, and be output. Since the search operation is performed not completely depending on the search keyword provided by the user, but performed in conjunction with the demand keyword obtained according to the search demand type to which the search keyword belongs, the search result substantially satisfies the user's real intention. Hence, this can avoid the problem about increased data interaction between the application and the search engine caused by repeated searches performed by the user via the application in the prior art, and thereby reduces the processing burden of the search engine.

In addition, according to the technical solutions provided by the present disclosure, since the search operation is performed not completely depending on the search keyword provided by the user, but performed in conjunction with the demand keyword obtained according to the search demand type to which the search keyword belongs, the search result substantially satisfies the user's real intention, thereby improving validity of the search result.

In addition, according to the technical solutions provided by the present disclosure, since the search operation is performed not completely depending on the search keyword provided by the user, but performed in conjunction with the demand keyword obtained according to the search demand type to which the search keyword belongs, the search result substantially satisfies the user's real intention, thereby improving the searching efficiency.

In addition, the user's experience can be improved effectively by using the technical solutions provided by the present disclosure.

### BRIEF DESCRIPTION OF DRAWINGS

To describe technical solutions of embodiments of the present disclosure more clearly, figures to be used in the embodiments or in depictions regarding the prior art will be described briefly. Obviously, the figures described below are only some embodiments of the present disclosure. Those having ordinary skill in the art appreciate that other figures may be obtained from these figures without making inventive efforts.

FIG. 1 is a flow chart of an artificial intelligence-based searching method according to an embodiment of the present disclosure;

FIG. 2 is a block diagram of an artificial intelligence-based searching apparatus according to another embodiment of the present disclosure;

FIG. 3 is a block diagram of an example computer system/server 12 adapted to implement an embodiment of the present disclosure.

### DETAILED DESCRIPTION OF PREFERRED EMBODIMENTS

To make objectives, technical solutions and advantages of embodiments of the present disclosure clearer, technical solutions of embodiment of the present disclosure will be described clearly and completely with reference to figures in embodiments of the present disclosure. Obviously, embodiments described here are partial embodiments of the present disclosure, not all embodiments. All other embodiments obtained by those having ordinary skill in the art based on the embodiments of the present disclosure, without making any inventive efforts, fall within the protection scope of the present disclosure.

It needs to be appreciated that the terminals involved in the embodiments of the present disclosure comprise but are not limited to a mobile phone, a Personal Digital Assistant (PDA), a wireless handheld device, a tablet computer, a Personal Computer (PC), an MP3 player, an MP4 player, and a wearable device (e.g., a pair of smart glasses, a smart watch, or a smart bracelet).

In addition, the term “and/or” used in the text is only an association relationship depicting associated objects and represents that three relations might exist, for example, A and/or B may represents three cases, namely, A exists individually, both A and B coexist, and B exists individually. In addition, the symbol “/” in the text generally indicates associated objects before and after the symbol are in an “or” relationship.

FIG. 1 is a flow chart of an artificial intelligence-based searching method according to an embodiment of the present disclosure. As shown in FIG. 1, the method comprises the following steps:

101: obtaining a search demand type according to a search keyword provided by the user;

102: obtaining a demand keyword according to the search keyword and a search pattern of the search demand type;

103: obtaining a search result according to the demand keyword;

104: outputting the search result.

It needs to be appreciated that subjects for executing 101-104 may partially or totally be an application located in a local terminal, or a function unit such as a plug-in or Software Development Kit (SDK) located in an application of the local terminal, or a search engine located in a network-side server, or a distributed type system located on the network side. This is not particularly limited in the present embodiment.

It may be understood that the application may be a native application (nativeAPP) installed on the terminal, or a webpage program (webApp) of a browser on the terminal. This is not particularly limited in the present embodiment.

As such, the search demand type is obtained according to the search keyword provided by the user, then the demand keyword is obtained according to the search keyword and the search pattern of the search demand type so that the search result can be obtained according to the demand keyword, and be output. Since the search operation is performed not completely depending on the search keyword provided by the user, but performed in conjunction with the demand keyword obtained according to the search demand type to which the search keyword belongs, the search result substantially satisfies the user's real intention. Hence, this can avoid the problem about increased data interaction between the application and the search engine caused by repeated searches performed by the user via the application in the prior art, and thereby reduces the processing burden of the search engine.

Optionally, in a possible implementation mode of the present embodiment, before 101, it is feasible to further obtain the search keyword provided by the user. Specifically, it is feasible to collect the search keyword provided by the user. Specifically, this may be implemented by a search command triggered by the user. Specifically, the search command may be trigged in the following manners but not limited to the following manners:

Manner 1:

The user may input the search keyword on a page displayed by the current application, and then click a search button such as “do Baidu search” on the page to trigger the search command which includes the search keyword. An order in which the user inputs the search keyword may be any order. As such, after the search command is received, the search keyword included in the search command may be obtained by parsing.

Manner 2:

It is feasible to employ an asynchronous loading technique such as Ajax asynchronous loading or Jsonp asynchronous loading to obtain, in real time, input content that is input by the user on the page displayed by the current application. To differentiate from the search keyword, the input content at this time may be called input keyword. An order in which the user inputs the search keyword may be any order. Specifically, an interface such as Ajax interface or Jsonp interface may be provided. These interfaces may perform write in a language such as Java or Hypertext Preprocessor (PHP), and its specific call may use Jquery or a language such as native JavaScript to write.

Manner 3: the user may long-press a speech search button on the page displayed by the current application, speak out speech content to be input, and then release the speech search button to trigger the search command. The search command includes the search keyword in a text form converted from the spoken speech content. As such, after the search command is received, the search keyword included in the search command may be obtained by parsing.

Manner 4: the user may click the speech search button on the page displayed by the current application, speak out the speech content to be input, and then trigger the search command after a period of time for example 2 seconds following completion of the speaking of the speech content. The search command includes the search keyword in a text form converted from the spoken speech content. As such, after the search command is received, the search keyword included in the search command may be obtained by parsing.

After the input keyword is obtained, subsequent operations, namely, 101-104 may be executed.

Optionally, in a possible implementation mode of the present embodiment, before 101, it is feasible to further obtain commonly-used keywords in a designated field such as the field of ancient poetry, and then classify the commonly-used keywords to obtain at least one search demand type in the designated field.

Wherein, the search demand type may include but not limited to precise demand type, type demand type (including combinations of different types) or generic demand type. This is not specially limited in the present embodiment.

For example, the type demands in the field of ancient poetry may include but not limited to at least one of dynasty type, author type, keynote or emotion type and genre type. This is not specially limited in the present disclosure.

Specifically, it is feasible to collect commonly-used keywords in a designated field, and then classify the commonly-used keywords to obtain at least one search demand type in the designated field.

After the search demand type of each commonly-used keyword is obtained, it may be regarded as a training sample to respectively build a semantic parsing model and a semantic matching model.

For example, it is specifically feasible to use training samples included in a training sample set to train to respectively build the semantic parsing model and the semantic matching model.

It needs to be appreciated that the training samples included in the training sample set may be known samples which are already annotated, so that these known samples may be directly used for training to build a target model, namely, the semantic parsing model or the semantic matching mode; or, the training samples may be partly known samples which are already annotated and partly unknown samples which are not yet annotated, so that it is feasible to first use the known samples for training to build an initial model, then use the initial model to predict the unknown samples to obtain a classification result, then annotate the unknown samples according to the classification results of the unknown samples, to form known samples as newly-added known samples, use the newly-added known samples and original known samples to re-train to build a new model until the built model or known samples satisfy a cutoff condition of the target model, for example, a classification accuracy rate is larger than or equal to a preset accuracy threshold or the number of known samples is larger than or equal to a preset number threshold. This is not specially limited in the present embodiment.

The so-called semantic parsing model is used to classify the search keyword provided by the user, to obtain the search demand type to which the search keyword belongs.

The so-called semantic matching model is used to use a search pattern of the search demand type to perform matching processing for the search keyword, to obtain a slot as the demand keyword. Specifically, a plurality of search patterns may be defined in the semantic matching model. Each search demand type may correspond to one search pattern. Each search pattern may include a plurality of factors. Among these factors, one or more key factors exist and may be called slots and used to serve as the demand keywords.

A pattern can cover a manner of an expression (not a specific sentence). A reasonable pattern is initially built to make a recall rate of the search keyword reach 80%, and later, the recall rate of the search keywords can be enabled to reach 95% by improving the pattern through collection of the search keywords actually used by the user.

Wherein each factor in the pattern can be satisfied by a self-constructed dictionary, for example, a dictionary corresponding to the factor author includes names of all poets.

It needs to be appreciated that the sematic parsing model and the semantic matching model may be two independent function models, or a complete merged model. This is not specially limited in the present embodiment.

Take the field of ancient poetry as an example to illustrate the technical solution according to the present disclosure in detail.

A. The search keyword provided by the user is “I want to listen to the poem Thoughts in the Silent Night (Chinese expression: [symbol] [symbol] )”.

It is feasible to use the semantic parsing model to perform parsing processing for the search keyword “I want to listen to the poem Thoughts in the Silent Night (Chinese expression: [symbol] [symbol] )”, and determine that the search demand type corresponding to the search keyword is the precise demand type, then use the search pattern pattern=want_words+author+title defined in the semantic matching model to perform matching processing for the search keyword “I want to listen to the poem Thoughts in the Silent Night ( [symbol] [symbol] )” to obtain values of respective factors, namely, the factor want words is “want to listen to (Chinese expression: [symbol] )”, the author factor is “Li Bai (Chinese expression: [symbol] )”, and the title factor is “Thoughts in the Silent Night (Chinese expression: [symbol] )”, wherein the slots may be the author factor “Li Bai (Chinese expression: [symbol] )” and the title factor “Thoughts in the Silent Night (Chinese expression: [symbol] )”. “I (Chinese expression: [symbol] )” and “of (Chinese expression: [symbol] )” belong to negligible words. As such, it is possible to use the slots, namely the author factor “Li Bai (Chinese expression: [symbol] )” and the title factor “Thoughts in the Silent Night (Chinese expression: [symbol] )” to search in an ancient poetry resource repository, and precisely return a certain ancient poem wanted by the user.

B. The search keyword provided by the user is “I want to listen to a bamboo-describing poem in Tang Dynasty (Chinese expression: [symbol] [symbol] [symbol] )”.

It is feasible to use the semantic parsing model to perform parsing processing for the search keyword “I want to listen to a bamboo-describing poem in Tang Dynasty (Chinese expression: [symbol] [symbol] )”, and determine that the search demand type corresponding to the search keyword is the type demand type, namely, the dynasty type is Tang Dynasty, and the keynote type is describing bamboos, then use the search pattern pattern=want_words+dynasty+describe+tag+poem defined in the semantic matching model to perform matching processing for the search keyword “I want to listen to a bamboo-describing poem in Tang Dynasty (Chinese expression: [symbol] [symbol] )” to obtain values of respective factors, namely, the factor want words is “want to listen to [symbol] )”, the dynasty factor is “Tang Dynasty”, the describe factor is describing, the tag factor is “bamboo”, and the poem factor is “poem”, wherein the slots may be the dynasty factor “Tang Dynasty” and the tag factor “bamboo”. “I (Chinese expression: [symbol] )” and “of (Chinese expression: [symbol] )” belong to negligible words. As such, it is possible to use the slots, namely the dynasty factor “Tang Dynasty” and the tag factor “bamboo” to search in an ancient poetry resource repository, and return a corresponding ancient poem list.

C. The search keyword provided by the user is “I want to listen to ancient poems (Chinese expression: [symbol] )”.

It is feasible to use the semantic parsing model to perform parsing processing for the search keyword “I want to listen to ancient poems (Chinese expression: [symbol] [symbol] )”, and determine that the search demand type corresponding to the search keyword is the generic demand type, then use the search pattern pattern=want_words+poem defined in the semantic matching model to perform matching processing for the search keyword “I want to listen to ancient poems (Chinese expression: [symbol] [symbol] )” to obtain values of respective factors, namely, the factor want words is “want to listen to (Chinese expression: [symbol] )”, and the poem factor is “ancient poems”, wherein the slot may be the poem factor is “ancient poems”. “I (Chinese expression: [symbol] )” belongs to a negligible word. As such, it is possible to use the slot, namely, the poem factor “ancient poems”, to search in an ancient poetry resource repository, and return a corresponding ancient poem list.

Optionally, in a possible implementation mode of the present embodiment, in 104, it is specifically feasible to rank the search results according to heat data of the search results and the user's user inclinations, and then output the ranked search results.

Specifically, before 104, it is also feasible to further obtain the heat data of the search results and the user's user inclinations.

In a specific implementation procedure, it is specifically feasible to collect heat data of the search results generated by various algorithms in the prior art, which will not be detailed any longer.

In another specific implementation procedure, it is specifically feasible to perform multiple rounds of search in a way that the user provides search keywords repeatedly, to thereby analyze to obtain the user's user inclination.

For example, the user provides a first search keyword: recommend several ancient poems to me (Chinese expression: [symbol] [symbol] );

The search engine returns word search results: Thoughts in the Silent Night (Chinese expression: [symbol] ), Looking at Mountain Tai (Chinese expression: [symbol] ) and the like. Or, the search engine returns speech search results: Thoughts in the Silent Night (Chinese expression: [symbol] ), Looking at Mountain Tai (Chinese expression: [symbol] [symbol] ) and the like; which one do you like?

The user provides a second search keyword: try Thoughts in the Silent Night (Chinese expression: [symbol] ) (at this time, the user inclination may be recorded);

The search engine outputs/broadcasts a search result: Thoughts in the Silent Night (Chinese expression: [symbol] ).

In the present disclosure, the recall rate of the search keyword is high, the user particularly children's demands can be understood very well in the search scenario of ancient poetry, and the user's anticipation can be satisfied in respect of the precise demand type, the type demand type and the generic demand type. In addition, since multiple rounds of search are introduced and the user indication is obtained by recommending a feedback mechanism, the user's experience is improved.

In the present embodiment, the search demand type is obtained according to the search keyword provided by the user, then the demand keyword is obtained according to the search keyword and the search pattern of the search demand type so that the search result can be obtained according to the demand keyword, and be output. Since the search operation is performed not completely depending on the search keyword provided by the user, but performed in conjunction with the demand keyword obtained according to the search demand type to which the search keyword belongs, the search result substantially satisfies the user's real intention. Hence, this can avoid the problem about increased data interaction between the application and the search engine caused by repeated searches performed by the user via the application in the prior art, and thereby reduces the processing burden of the search engine.

In addition, according to the technical solution provided by the present disclosure, since the search operation is performed not completely depending on the search keyword provided by the user, but performed in conjunction with the demand keyword obtained according to the search demand type to which the search keyword belongs, the search result substantially satisfies the user's real intention, thereby improving validity of the search result.

In addition, according to the technical solution provided by the present disclosure, since the search operation is performed not completely depending on the search keyword provided by the user, but performed in conjunction with the demand keyword obtained according to the search demand type to which the search keyword belongs, the search result substantially satisfies the user's real intention, thereby improving the searching efficiency.

In addition, the user's experience can be improved effectively by using the technical solution provided by the present disclosure.

It needs to be appreciated that regarding the aforesaid method embodiments, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, different emphasis is placed on respective embodiments, and reference may be made to related depictions in other embodiments for portions not detailed in a certain embodiment.

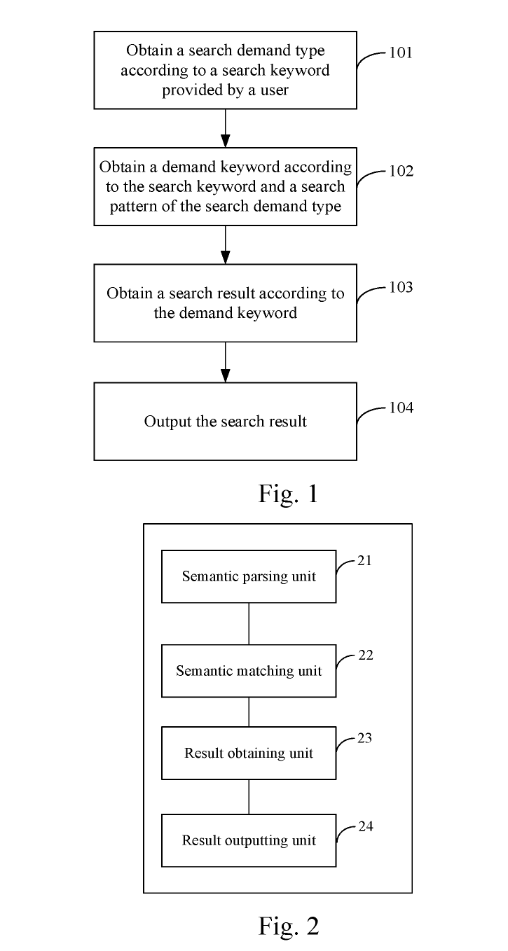

FIG. 2 is a block diagram of an artificial intelligence-based searching apparatus according to another embodiment of the present disclosure. As shown in FIG. 2, the artificial intelligence-based searching apparatus according to the present embodiment may comprise a semantic parsing unit 21, a semantic matching unit 22, a result obtaining unit 23 and a result outputting unit 24, wherein the semantic parsing unit 21 is configured to obtain a search demand type according to a search keyword provided by the user; the semantic matching unit 22 is configured to obtain a demand keyword according to the search keyword and a search pattern of the search demand type; the result obtaining unit 23 is configured to obtain a search result according to the demand keyword; the result outputting unit 24 is configured to output the search result.

It needs to be appreciated that the artificial intelligence-based searching apparatus according to the present embodiment may partially or totally be an application located in a local terminal, or a function unit such as a plug-in or Software Development Kit (SDK) located in an application of the local terminal, or a search engine located in a network-side server, or a distributed type system located on the network side. This is not particularly limited in the present embodiment.

It may be understood that the application may be a native application (nativeAPP) installed on the terminal, or a webpage program (webApp) of a browser on the terminal. This is not particularly limited in the present embodiment.

Optionally, in a possible implementation mode of the present embodiment, the semantic parsing unit 21 is further configured to obtain commonly-used keywords in a designated field; and classify the commonly-used keywords to obtain at least one search demand type in the designated field.

Wherein, the designated field may include but not limited to the field of ancient poetry. This is not particularly limited in the present embodiment.

Wherein the search demand type may include but not limited to precise demand type, type demand type (including combinations of different types) or generic demand type. This is not specially limited in the present embodiment.

For example, the type demands in the field of ancient poetry may include but not limited to at least one of dynasty type, author type, keynote or emotion type and genre type. This is not specially limited in the present disclosure.

Optionally, in a possible implementation mode of the present embodiment, the outputting unit 24 is specifically configured to rank the search results according to heat data of the search results and the user's user inclinations; and output the ranked search results.

It needs to be appreciated that the method in the embodiment corresponding to FIG. 1 may be implemented by the artificial intelligence-based searching apparatus according to the present embodiment. Detailed description will not be detailed any longer here, and reference may be made to relevant content in the embodiment corresponding to FIG. 1.

In the present embodiment, the search demand type is obtained according to the search keyword provided by the user, then the demand keyword is obtained according to the search keyword and the search pattern of the search demand type so that the search result can be obtained according to the demand keyword, and be output. Since the search operation is performed not completely depending on the search keyword provided by the user, but performed in conjunction with the demand keyword obtained according to the search demand type to which the search keyword belongs, the search result substantially satisfies the user's real intention. Hence, this can avoid the problem about increased data interaction between the application and the search engine caused by repeated searches performed by the user via the application in the prior art, and thereby reduces the processing burden of the search engine.

In addition, according to the technical solution provided by the present disclosure, since the search operation is performed not completely depending on the search keyword provided by the user, but performed in conjunction with the demand keyword obtained according to the search demand type to which the search keyword belongs, the search result substantially satisfies the user's real intention, thereby improving validity of the search result.

In addition, according to the technical solution provided by the present disclosure, since the search operation is performed not completely depending on the search keyword provided by the user, but performed in conjunction with the demand keyword obtained according to the search demand type to which the search keyword belongs, the search result substantially satisfies the user's real intention, thereby improving the searching efficiency.

In addition, the user's experience can be improved effectively by using the technical solution provided by the present disclosure.

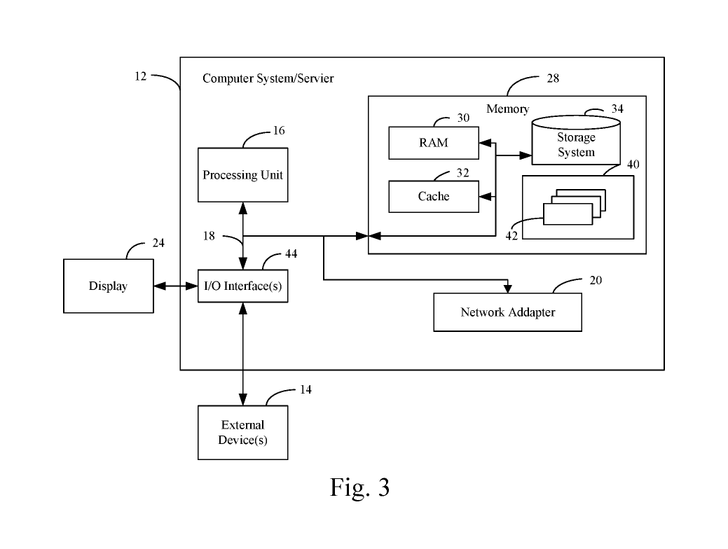

FIG. 3 is a block diagram of an exemplary computer system/server 12 adapted to implement the embodiment of the present disclosure. The computer system/server 12 shown in FIG. 3 is only an example and should not bring about any limitation to the function and range of use of the embodiments of the present disclosure.

As shown in FIG. 3, the computer system/server 12 is shown in the form of a general-purpose computing device. The components of computer system/server 12 may include, but are not limited to, one or more processors or processing units 16, a storage device or system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 46. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. The memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 44. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The processing unit 16 executes various function applications and data processing by running programs stored in the system memory 28, for example, implement the artificial intelligence-based searching method provided by the embodiment corresponding to FIG. 1.

Anther embodiment of the present disclosure further provides a computer-readable storage medium on which a computer program is stored. The program, when executed by a processor, implements the artificial intelligence-based searching method provided by the embodiment corresponding to FIG. 1.

Specifically, any combinations of one or more computer-readable media may be employed. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be a tangible device that can retain and store instructions for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Those skilled in the art can clearly understand that for purpose of convenience and brevity of depictions, reference may be made to corresponding procedures in the aforesaid method embodiments for specific operation procedures of the system, apparatus and units described above, which will not be detailed any more.

In the embodiments provided by the present disclosure, it should be understood that the revealed system, apparatus and method can be implemented in other ways. For example, the above-described embodiments for the apparatus are only exemplary, e.g., the division of the units is merely logical one, and, in reality, they can be divided in other ways upon implementation. For example, a plurality of units or components may be combined or integrated into another system, or some features may be neglected or not executed. In addition, mutual coupling or direct coupling or communicative connection as displayed or discussed may be indirect coupling or communicative connection performed via some interfaces, means or units and may be electrical, mechanical or in other forms.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

Finally, it is appreciated that the above embodiments are only used to illustrate the technical solutions of the present disclosure, not to limit the present disclosure; although the present disclosure is described in detail with reference to the above embodiments, those having ordinary skill in the art should understand that they still can modify technical solutions recited in the aforesaid embodiments or equivalently replace partial technical features therein; these modifications or substitutions do not cause essence of corresponding technical solutions to depart from the spirit and scope of technical solutions of embodiments of the present disclosure.

What is claimed is:

1. An artificial intelligence-based searching method, wherein the method comprises:
obtaining a search demand type according to a search keyword provided by a user;
obtaining a demand keyword according to the search keyword and a search pattern of the search demand type;
obtaining a search result according to the demand keyword;
outputting the search result.

2. The method according to claim 1, wherein before the obtaining a search demand type according to a search keyword provided by a user, the method further comprises:
obtaining commonly-used keywords in a designated field;
classifying the commonly-used keywords to obtain at least one search demand type in the designated field.

3. The method according to claim 1, wherein the designated field comprises a field of ancient poetry.

4. The method according to claim 1, wherein the search demand type comprises precise demand type, type demand type or generic demand type.

5. The method according to claim 1, wherein the outputting the search result comprises:
ranking the search results according to heat data of the search results and the user's user inclinations;
outputting the ranked search results.

6. A device, wherein the device comprises:
one or more processors;
a memory for storing one or more programs,
the one or more programs, when executed by said one or more processors, enable said one or more processors to implement the following operation:
obtaining a search demand type according to a search keyword provided by a user;
obtaining a demand keyword according to the search keyword and a search pattern of the search demand type;
obtaining a search result according to the demand keyword;
outputting the search result.

7. The device according to claim 6, wherein before the obtaining a search demand type according to a search keyword provided by a user, the operation further comprises:
obtaining commonly-used keywords in a designated field;
classifying the commonly-used keywords to obtain at least one search demand type in the designated field.

8. The device according to claim 6, wherein the designated field comprises a field of ancient poetry.

9. The device according to claim 6, wherein the search demand type comprises precise demand type, type demand type or generic demand type.

10. The device according to claim 6, wherein the outputting the search result comprises:
ranking the search results according to heat data of the search results and the user's user inclinations;
outputting the ranked search results.

11. A computer readable medium on which a computer program is stored, wherein the program, when executed by a processor, implements the following operation:
obtaining a search demand type according to a search keyword provided by a user;
obtaining a demand keyword according to the search keyword and a search pattern of the search demand type;
obtaining a search result according to the demand keyword;
outputting the search result.

12. The computer readable medium according to claim 11, wherein before the obtaining a search demand type according to a search keyword provided by a user, the operation further comprises:
obtaining commonly-used keywords in a designated field;
classifying the commonly-used keywords to obtain at least one search demand type in the designated field.

13. The computer readable medium according to claim 11, wherein the designated field comprises a field of ancient poetry.

14. The computer readable medium according to claim 11, wherein the search demand type comprises precise demand type, type demand type or generic demand type.

15. The computer readable medium according to claim 11, wherein the outputting the search result comprises:
ranking the search results according to heat data of the search results and the user's user inclinations;
outputting the ranked search results.
